(19) United States
(12) Patent Application Publication
(10) Pub. No.: US 2004/0207728 A1
(43) Pub. Date: Oct. 21, 2004

(54) Image server and an image server system

(75) Inventors: Toshiyuki Kihara, Munakata-gun (JP); Yuji Arima, Ogouri-shi (JP); Tadashi Yoshikai, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/771,517

(22) Filed: Feb. 5, 2004

(30) Foreign Application Priority Data
Feb. 5, 2003 (JP) P.2003-28029

(51) Int. Cl. H04N 9/47

(52) U.S. Cl. 348/143

(57) ABSTRACT

The invention allows the user to operate the camera of an image server via a network and acquire via voice the information associated with the imaging position of the camera.

In the storage of the image server is provided a table which associates voice data with imaging position data of said camera. In case the imaging position of the camera corresponds to the imaging position data in the table, the image server selects the selects voice data associated with said imaging position data and a network server section transmits the voice data to said client terminal.

This allows voice data corresponding to the imaging position and preset information to be output thereby providing a voice guidance appropriate for the imaging details.

### BACKGROUND OF THE INVENTION

1. Field of the Invention

The present invention relates to an image server capable of operating a camera to image a picture and transmitting the picture to a client terminal and an image server system comprising the client terminal and the image server.

2. Description of the Related Art

In recent years, image servers have been developed which is connected to a network such as the Internet or a LAN and is capable of providing the data of an image imaged with a camera to a remote terminal over the network. It has not been easy to simultaneously display a plurality of images transmitted over the network on the display of a client terminal. Thus, the applicant of the invention proposed an image server and an image server system capable of displaying a plurality of images having separate IP addresses received from the image server (Japanese Patent Laid-Open No. 2002-108730).

According to the image server system, the IP address of a destination, the proper name of the location of an image server and a password therefore are used as display information data. The image server generates an HTML file which reflects the proper name and is associated with the image display position, and transmits the HTML file to a client terminal for display on the browser screen of the client terminal.

Same as the image server of the Japanese Patent Laid-Open No. 2002-108730, an integral-type Internet camera has been proposed which comprises a character generator and generates a bit map character string in accordance with a font internally stored and changes the memory value in an image memory so as to overlay text information on a digital image stored (Japanese Patent Laid-Open No. 2000-134522). This camera changes the value of an area corresponding to color information on the image coordinates of an image stored.

However, the integral-type Internet camera of the Japanese Patent Laid-Open No. 2000-134522 only writes a comment string such as the date and time of photographing and imaging angle of the camera and changes the memory value by overlaying text information on the image. Thus the text information is prepared on a per image basis. This approach writes a memo about the date of and conditions for imaging on an individual image.

As mentioned above, the image server of the Japanese Patent Laid-Open No. 2002-108730 generates an HTML file which reflects the proper name and is associated with the image display position, and transmits the HTML file to a client terminal for display on the browser screen of the client terminal. However, the text information associated with the HTML file is described in order to facilitate input of a URL required when an image is requested from another image server, and is not information associated with the imaging position information of the camera for the imaged image, or information associated with the angle transmitted from an image server. Additionally, such information has smaller volume of information and it is burdensome to read the related information in real time or under similar conditions.

The information relates to an image imaged by the integral-type Internet camera of the Japanese Patent Laid-Open No. 2000-134522 is just an individual memo written over an individual image, and is not information associated with the camera imaging angle or to an image imaged by a camera in a specific position among the plurality of cameras. The text information written over an image has a small volume of information and an increased volume of information degrades the clarity of the image.

### SUMMARY OF THE INVENTION

The invention, in view of the aforementioned related art problems, aims at providing an image server which allows the user to operate the camera of the image server via a network and acquire by way of voice the information associated with the imaging position of the camera.

In order to attain the object, a first aspect of the invention provides an image server connected to a network which controls a camera within each imaging position range based on a request from a client terminal via the network, the image server comprising: a storage for storing voice data to be regenerated on a client terminal and a table which associates the voice data with imaging position data of the camera; and a controller which, in case the imaging position of the camera corresponds to the imaging position data in the table, selects voice data associated with the imaging position data and controls a network server section to transmit the voice data to the client terminal. With this configuration, the user can operate the camera of the image server via a network and acquire via voice the information associated with a imaging position by way of a table for associating voice data with the imaging position data of the camera.

According to a second aspect of the invention, the table stores the imaging position data indicating the imaging position range, imaging time information and voice data while associating their storage locations with one another. With this configuration, voice data can be identified from the imaging position and the imaging time information various voice data can be readily fetched depending on the imaging time.

According to a third aspect of the invention, the storage stores a display selection table for selecting display information associated with the imaging position data of the camera. By placing the camera in a predetermined imaging position, display information such as a web page transmitted to a client terminal for display can be readily selected. A telop display area for displaying telop-format indication information is provided in the display information. This notifies information associated with the imaging position by way of a telop.

A fourth aspect of the invention provides an image server comprising a storage for storing voice data to be regenerated on a client terminal and a table which associates the voice data with imaging position data of the camera, wherein the controller selects, in case it has received a imaging position change request including present information from the client terminal, selects voice data associated with the preset number, and wherein the network server section transmits the voice data to the client terminal. With this configuration, the user can operate the camera of the image server via a network and acquire the information associated with the imaging position of the camera by way of a table which associates voice data with preset information.

A fifth aspect of the invention provides an image server connected to a network which controls a camera within each imaging position range based on a request from a client terminal via the network, the image server comprising a storage for storing voice data to be regenerated on a client terminal and a table which associates the voice data with imaging position data of the camera, wherein in case the imaging position of the camera corresponds to the imaging position data in the table, the network server section makes a request to a voice server connected to a network which stores voice data to transmit the voice data. With this configuration, the user can operate the camera of the image server via a network and acquire voice data by way of a voice server.

A sixth aspect of the invention provides an image servers system comprising: an image server connected to a network which controls a camera within each imaging position range and transmits an image; and a client terminal which controls the camera via the network; the image server including a storage for storing voice data to be regenerated on a client terminal and a table which associates the voice data with imaging position data of the camera, wherein the image server, in case the imaging position of the camera corresponds to the imaging position data in the table, selects voice data associated with the imaging position data and transmits the voice data to the client terminal. With this configuration, the user can operate the camera of the image server via a network and acquire via voice the information associated with a imaging position by way of a table for associating voice data with the imaging position data of the camera.

According to an seventh aspect of the invention, a storage is provided for storing a program which causes a computer to act as means for selecting voice data. When a client terminal makes a request to transmit an image, the image server transmits the program, voice data and table to the client terminal as well as a imaged image and imaging position information. The client terminal, receiving the image, uses the program to select voice data to regenerate voice. With this configuration, a program and voice data as well as table information are transmitted from an image server to a terminal. This eliminates the need for processing voice on the image server. Once image data is downloaded to a client terminal, the user can conformably operate the camera via a network and voice data associated with the imaging position of the camera can be delivered as voice by way of the internal processing of the terminal.

A eight aspect of the invention provides an image server system which comprises a voice server for storing voice data to be regenerated on a client terminal wherein, on a request for an image from the client terminal, in case the imaging position of the camera corresponds to the imaging position data in the table, the controller of the image server selects voice data associated with the imaging position data and the image server transmits the voice data to the client terminal. With this configuration, voice data can be stored in a voice server. This eliminates the need for processing voice on the image server. The user can conformably operate the camera via a network. Simply by providing a voice server for voice processing, it is readily possible to acquire via voice the information associated with the imaging position.

### BRIEF DESCRIPTION OF THE DRAWINGS

FIG. 1 is a block diagram of an image server system comprising an image server and a terminal according to Embodiment 1 of the invention;

FIG. 2 is a block diagram of an image server according to Embodiment 1 of the invention;

FIG. 3 is a block diagram of a client terminal according to Embodiment 1 of the invention;

FIG. 4 explains the control screen displayed on the terminal according to Embodiment 1 of the invention;

FIG. 5 explains the relation between the imaging position information and voice data;

FIG. 6A is a relation diagram which associates a imaging position range and an associating time zone with a voice data number;

FIG. 6B is a relation diagram which associates the present number of voice and an associating time zone with a voice data number;

FIG. 7 is a sequence chart of acquisition of the image and voice information in the image server system according to Embodiment 1 of the invention;

FIG. 8 is a flowchart of voice data read processing according to Embodiment 1 of the invention;

FIG. 9 is a sequence chart of acquisition of the image and voice information in the image server system according to Embodiment 1 of the invention;

FIG. 10 explains the preset table of the image server according to Embodiment 1 of the invention;

FIG. 11 is a sequence chart of acquisition of the image and voice information in the image server system according to Embodiment 1 of the invention;

FIG. 12 is a flowchart of voice data read processing according to Embodiment 2 of the invention;

FIG. 13A is a second flowchart of voice data read processing according to Embodiment 2 of the invention;

FIG. 13B explains the matching determination of a set imaging position range;

FIG. 14 is a sequence chart of acquisition of an image and voice information in an image server system according to Embodiment 3 of the invention;

FIG. 15 is a flowchart of voice data read processing according to Embodiment 3 of the invention; and

FIG. 16 is a sequence chart of acquisition of an image in an image server system and voice regeneration from the image server.

### DESCRIPTION OF THE PREFERRED EMBODIMENTS

### Embodiment 1

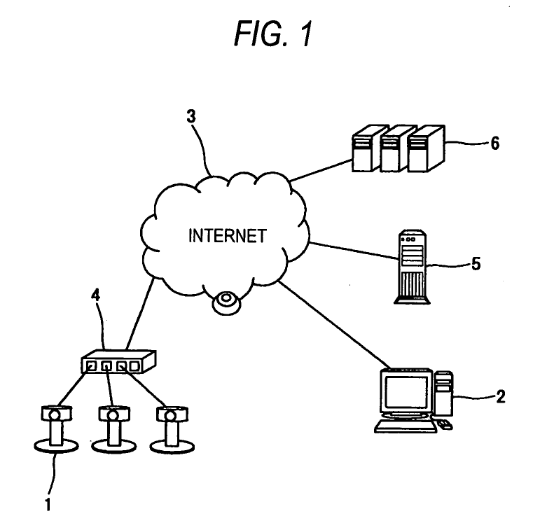

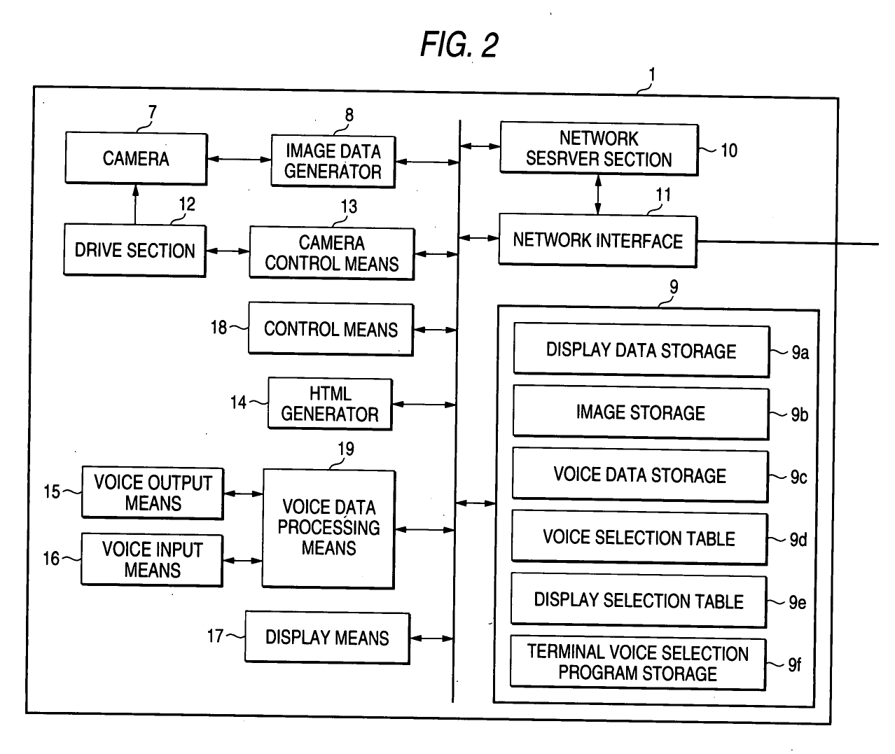

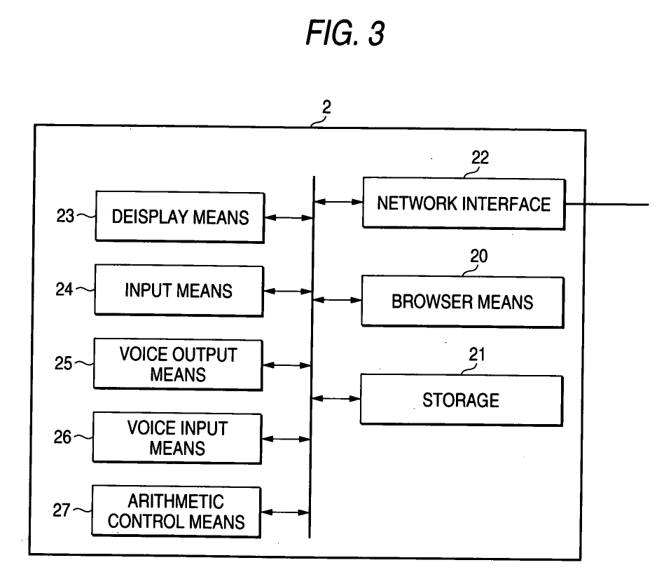

An image server according to Embodiment 1 of the invention is described below referring to drawings. FIG. 1 is a block diagram of an image server system comprising an image server and a terminal according to Embodiment 1 of the invention. FIG. 2 is a block diagram of an image server according to Embodiment 1 of the invention. FIG. 3 is a block diagram of a client terminal according to Embodiment 1 of the invention.

As shown in FIG. 1, an image server system according to Embodiment 1 is comprises a plurality of image servers 1, a terminal 2, and a network 3. The image server 1 has a capability of imaging a subject and transferring image data. The terminal 2 is for example a personal computer (PC). The terminal 2 mounts a browser. The user receives an image transferred from the image server 1 and displays the image on the terminal 1. The user cab control the image server 1 by using control data by way of a button on a web page received. The network 3 is a network such as the Internet on which communications are allowed using the TCP/IP protocol. A router 4 provided to connect the image server 1 and the terminal 2 to the network 3 transfers an image and transmits control data.

On the network 3 are provided a DNS server for converting a domain name to an IP address on an access to a site on the network 3 using the domain name, and a voice server 6 for transmitting voice data to the terminal 2 in response to a request from the image server 1. The voice server 6 will be detailed in Embodiment 3.

Next, the configuration of an image server according to Embodiment 1 is described below referring to FIG. 2. On the image server 1 shown in FIG. 2, a camera 7 is subject to control of a imaging position (panning/tilting) and zooming by way of control data from the network 3. The camera 7 images a subject converts the imaged image to picture signal and outputs the picture signal. Panning refers to side-by-side swing change and tilting a dislocation in the inclination angle in vertical direction. An image data generator 8 converts the picture signal output from the camera 7 to the luminance signal (Y) and color difference signals (Cb, Cr). Then the image data generator 8 performs image compression in a format such as the JPEG, motion JPEG or TIF so as to reduce the data volume to the communications rate on the network.

In a storage 9 for storing various information, a display data storage 9a stores display information such as a web page described in a markup language such as HTML (hereinafter referred to as the web page) and an image storage 9b stores image data generated by the image data generator 8 and other images. In the storage 9, a voice data storage 9c stores voice data input from a microphone or other voice input means 16 as mentioned later, or transmitted via the network 3. Voice data is a guidance message associated with panning, tilting and zooming data of the camera 7 (hereinafter referred to as imaging position data), for example a message such as “This is a picture of the entrance,” or “Avoid turning the camera counterclockwise since there is an obstacle.” Such a message is regenerated on the terminal 2.

In the storage 2, a voice selection table 9d stores voice data associated with the imaging position data of the camera 7 and a display selection table 9e stores information to identify a web page associated with the imaging position data of the camera 7. Either of these pages is selected depending on the imaging position data. In the storage 9, a terminal voice selection program storage 9f stores a voice program to be transmitted to expand the browser feature of the terminal 2. Operation of the voice selection program stored in the terminal voice selection program storage 9f will be described in Embodiment 2.

In the image server 2 shown in FIG. 2, a network server section 10 receives a camera imaging position change request for control of the camera 7 or panning, tilting or zooming control from the network 3 and transmits the image data and voice data compressed by the image data generator 8 to the terminal 2. A network interface 11 performs communications using the TCP/IP protocol between the network 3 and the image server 1. The drive section 12 is a mechanism for panning, tilting, zooming and setting of aperture opening and is used to change the imaging position and the angle of view. Camera control means 13 controls the drive section 12 in response to a camera imaging position change request transmitted from the terminal 2.

In the image server 1 shown in FIG. 2, an HTML generator 14 displays an image on the display of the terminal 2 as well as generates a web page which allows operation of the camera 7 by way of a GUI-format control button. Voice output means 15 expands voiced data compressed and stored in the ADPCM, LD-CELP or ASF format and outputs the obtained data from a loudspeaker. Voice input means 16 collects surrounding voice from a microphone and compresses the voice in the ADPCM, LD-CELP or ASF format then stores the compressed data. Display means 17 comprises a compact-size display to display various information. Control means (controller of the invention) 18 controls the system of the image sever 1. Voice data processing means 19 compresses the voice data input from the voice input means 16 in the ADPCM, LD-CELP or ASF format in response to a camera imaging position change request transmitted from the terminal 2 then stores the compressed data into the voice data storage 89c as well as reads the voice data stored in the voice data storage 9c and outputs the obtained data from the voice output means 15.

It is possible to store a message associated with the imaging position of the camera 7 into a voice data storage 9c and regenerate this message, for example the message “This is the start of imaging.” from a loudspeaker in accordance with a request for an image from the terminal 2.

A web page generated by the HTML generator 14 comprises layout information for operating the camera 7 and displaying an image described in a markup language such as HTML. A web page is generated and transmitted to the network 3 by the network server section 10 and transmitted to the terminal 2 as a destination by the network 3.

On the terminal 2, the web page transmitted via the network 3 is displayed as a control screen by the browser means 20 mentioned later. When the user of the terminal 2 operates, or clicks on an active area of the screen, for example a button, the browser means of the terminal 2 transmits operation information to the server 1. The server 1, receiving this operation means, fetches the operation information. The camera control means 13 controls the angle and zooming of the camera 7 in accordance with the operation information. In this way, a camera imaging position can be changed via remote control. It is thus possible to change the imaging position of a camera via remote control. In the image server 1, an image imaged by the camera 7 and the image is compressed by the image data generator 8. The image data thus generated is stored by the image data generator 8. The generated image data is stored into the image storage 9b and transmitted to the terminal 2 as required. In Embodiment1, voice data stored in the voice data storage 9c is transmitted to the terminal 2.

The terminal according to Embodiment 1 is described below referring to FIG. 3. In the terminal 2 shown in 2, a network interface 22 performs control of communications with a terminal or an image server via the network 3. Browser means 20 communicates information using the TCP/IP protocol via the network 3. Display means 23 displays information on the display. Input means 24 comprises a mouse and a keyboard. Voice output means 25 expands voice data compressed and stored in the ADPCM, LD-CELP or ASF format and outputs the obtained data from a loudspeaker. Voice input means 26 collects surrounding voice from a microphone and compresses the voice to data. Arithmetic control means 27 controls the system of the terminal 2 based on a program arranged in the storage 21.

In Embodiment1, the image server 1 performs photographing. A imaged image is compressed and transmitted to the terminal 2. The browser means 20 of the terminal 2 displays the transmitted image in position on the screen. When a control button on the control screen which appears in accordance with a web page transmitted from the image server 1, the browser means 20 transmits a camera imaging position change request to the image server 1. The image server 1 accordingly selects the angle and zooming of the camera in order to change the camera imaging position.

The image server according to Embodiment 1 transmits not only image data but also voice data stored in the voice data storage 9c to the terminal 2. The voice data is a message in the ADPCM, LD-CELP or ASF associated with a imaged image. The voice data can be expanded with the voice output means 25 and regenerated as a voice from a loudspeaker. As shown in Embodiment 3, when a real-time voice is requested on the careen, the image server 1 collects the voice from a microphone and transmits the voice to the terminal 2 and regenerates the voice from the voice output means of the terminal 2.

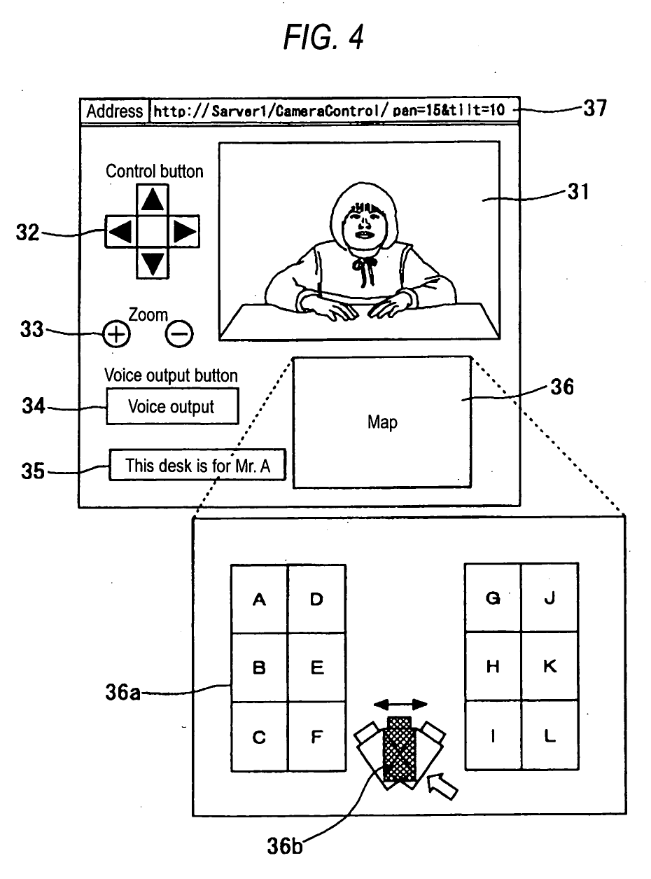

The control screen which appears on the display of the terminal 2 is described below. FIG. 4 explains the control screen displayed on the terminal according to Embodiment 1 of the invention. In FIG. 4, a numeral 31 represents an image area displaying the real-time image data imaged by the image server 1. 32 a control button for operating the imaging position (orientation) of the image server 1, and 33 a zoom button for zooming control. A numeral 34 is a voice output button provided to request voice output per client. Pressing the voice output button 34 transmits the voice such as a guidance message corresponding to the imaging position. A numeral 35 represents a telop display area where characters corresponding to the imaging position are displayed as a telop. A numeral 36 represents a map area which can be imaged by the image server 1 currently displayed.

A numeral 26a represents a map posted in the map area 36 and 36b an icon of the camera 7. In the map area 36 are displayed a map 36a which can be imaged by the camera 7 in the layout of FIG. 4 and an icon 36a indicating the orientation of the camera 7. The icon 36a is used to select the camera orientation in rough steps, for example in steps of 45 degrees. Then the control button 32 is used to perform minute adjustment for example in steps of 5 degrees. The control button 32 and the icon 36b may be used to change the shift width or either of these may be provided. When the control button 32 or the icon 36b is operated on the control screen, a control signal is transmitted to the image server 1 and the camera 7 is repositioned.

A numeral 27 is the URL of the image server 1. At the end of the URL 37 is specified the panning/tilting direction. The network server section 10 of the image server 1 can fetch this information and transfer the information to the camera control means 13.

Pressing the voice output button 34 transmits the corresponding information to the image server 1 when a camera imaging position change request is transmitted to the image server 1. The image server 1 turns ON the voice output mode corresponding to the terminal 1 whose voice output button 34 has been pressed. In the voice output mode, voice data and an image are received from the voice data storage 9c. Voice may be requested per client. Pressing the button in the voice output mode transmits a voice corresponding to the imaging position from the server. Once output, voice is not output as long as the camera is within its imaging position range. Pressing the button again in the vice output mode transmits the voice corresponding to the imaging position again from the server. Voice transmission request may be made so as to transmit in real time a surrounding voice from a microphone to the image server 1 by using the voice output button 34 or another voice button (not shown).

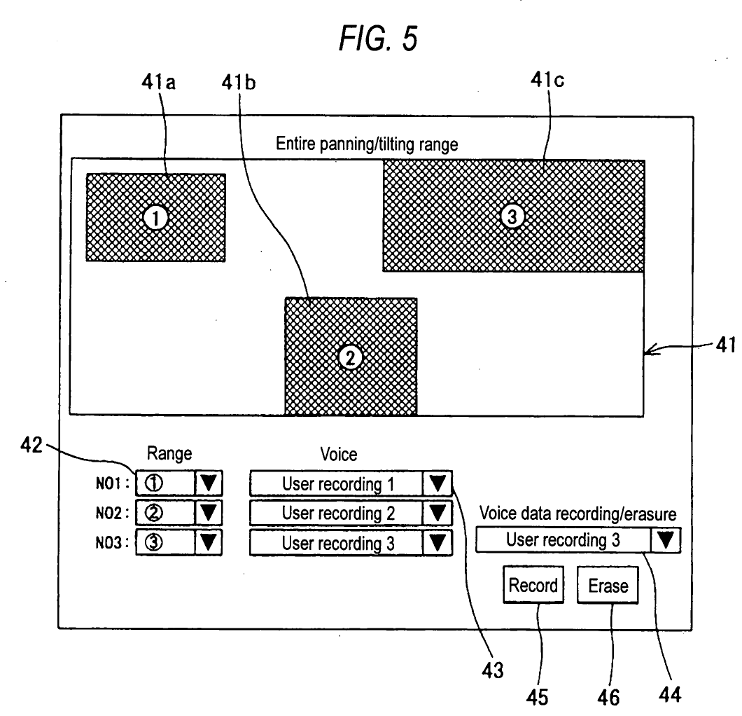

While the control screen has been described above, processing to associate imaging position information with voice data will be described. FIG. 5 shows the association of imaging position with voice data on the browser screen of the terminal for setting and a setting input screen for various setting. In FIG. 5, a numeral 41 represents the whole range of panning and tilting displayed on the setting input screen of the terminal 2. Numerals 41a, 41b, 41c shows a imaging position range indicated by \mathring{0}, \mathring{2} and \mathring{3}. A numeral 42 represents a range setting column for identifying the imaging position range 41a, 41b, 41c. In the numeral setting column 42, a single column is provided in association with one area in the imaging position range and a voice setting column 43 is also associated. Clicking on the ▾ button in the voice setting column 43 displays a list (box) of recorded data, from which the user can select a voice item. In case selection is made here, the selected voice is output once when the camera is oriented to the corresponding imaging position.

A numeral 44 represent voice data recording/erasure column, 45 a recording button and 46 an erasure button. When the user clicks on the ▾ button in the voice data recording/erasure column, a list box of registered voice data numbers is displayed. The user can select a voice data number to be recorded or erased. The voice data can be registered for example up to the number 100.

When the user presses the recording button 45 or erase button 46 with a voice data number selected as a target performs recording of data anew or erase a registered message. The setting screen preferably displays the message “User recording 4 is complete.” after recording and the message “User recording 4 is being erased.” before erasure starts. The user sets the range setting column and voice setting column 43 on the screen then presses a registration button (not shown). This transmits the setting information to the image server 1 and registers the information to the voice selection table 9e of the image server 1.

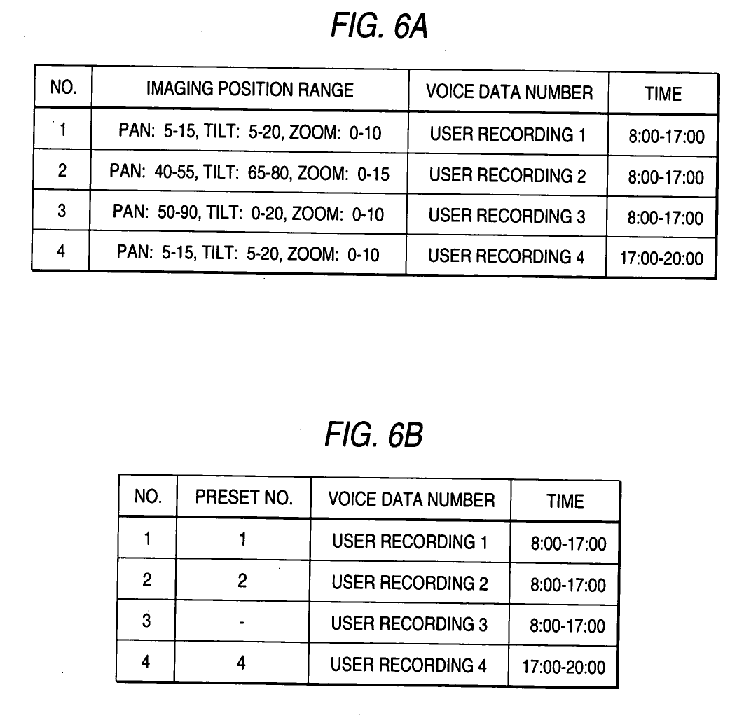

Next, the voice selection table used to associate a voice to a imaging position will be described. FIG. 6A is a relation diagram which associates a imaging position range and an associating time zone with a voice data number. FIG. 6B is a relation diagram which associates the present number of voice and an associating time zone with a voice data number.

In the voice selection table, a imaging position range is specified as shown in FIG. 6A. In case the user accesses the URL “http://Server1/CameraControl/pan=15&tilt=10” from the terminal 2 at the time 10:00, the network server section 10 of the image server 1 fetches the control data of panning: 15, tilting: 10 and zooming 10 from this voice selection table as well as checks the time against built-in clock means (not shown). In the example of FIG. 6A, “NO. 1: User Recording 1” is assumed and the corresponding address (not shown) in the voice data storage 9c is referenced to read User Recording 1 from the voice data storage 9c and transmit the recording data to the terminal 2.

It is possible, instead of specifying the imaging position range and requesting voice data as in FIG. 6A, to download a voice selection program which associates, on the control screen, all voice data in the voice data storage 9c with voice data numbers and select a voice data item and regenerate it together with the transmitted image. In FIG. 6B, the time is checked against built-in clock means (not shown) and a corresponding address in the voice data storage 9c is referenced from the user recording and the time of association, then the user recording having a predetermined preset number is read and regenerated on the terminal 2.

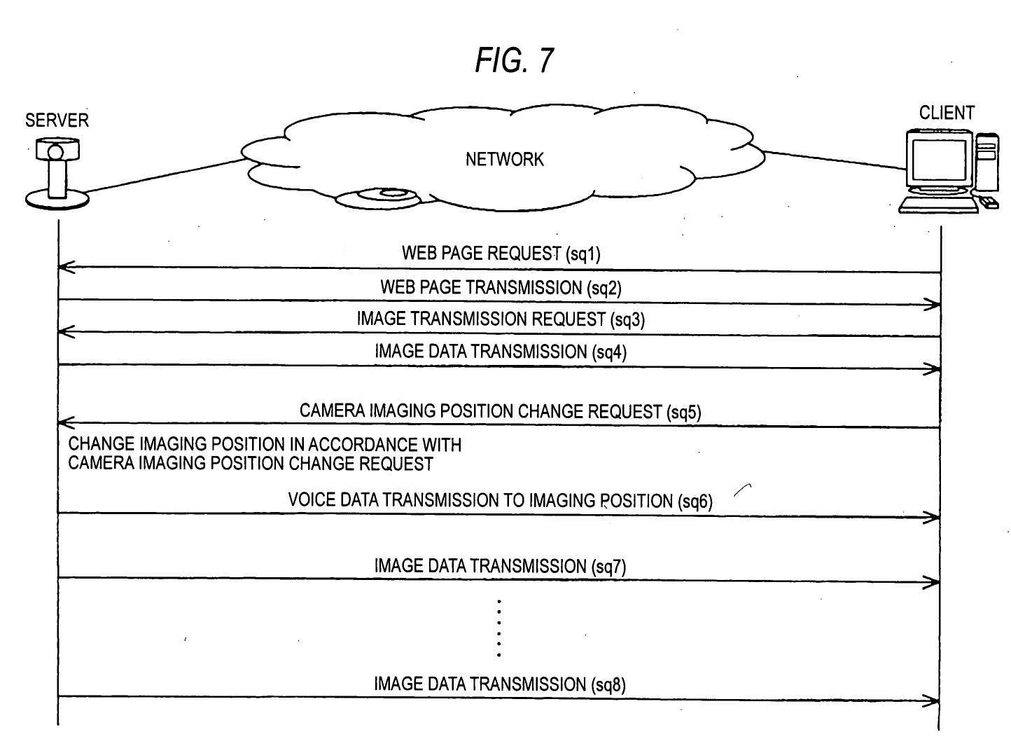

Next, the sequence of acquiring an image and a voice message on the terminal 2 from the image server 1 will be described. FIG. 7 is a sequence chart of acquisition of the image and voice information in the image server system according to Embodiment 1 of the invention.

On the client terminal 2, a web page of the control screen is requested from the image server 1 by using the protocol http via a network (sq1). The image server 1 transmits an HTML-based web page carrying layout information for displaying the operation buttons of the camera 7 and images (sq2). The terminal 2 receives the web page and the browser means displays the web page on the display. The user makes an image transmission request to the image server 1 by using the control buttons and icons on the control screen (sq3). The image server 1 reads successive still images encoded in the motion JPEG format and transmits the image data (sq4).

The user at the client browses the still images transmitted. In case the user wishes to browse images imaged in another imaging position, the client transmits a camera imaging position change request (sq5). The image server 1 operates the drive section 12 to change the camera imaging position, reads the voice data corresponding to the imaging position from the voice selection table, and transmits the voice data toward the terminal 2 (sq6). Further, the image server 1 transmits the image data of successive still images imaged in another orientation and encoded in the motion JPEG format (sq7). The image server 1 transmits successive still pictures by repeating sq5 trough sq7 (sq8). While the center position of an image imaged with the camera is used as the imaging position of the camera in this example, any position which shows the relative camera position may be used instead.

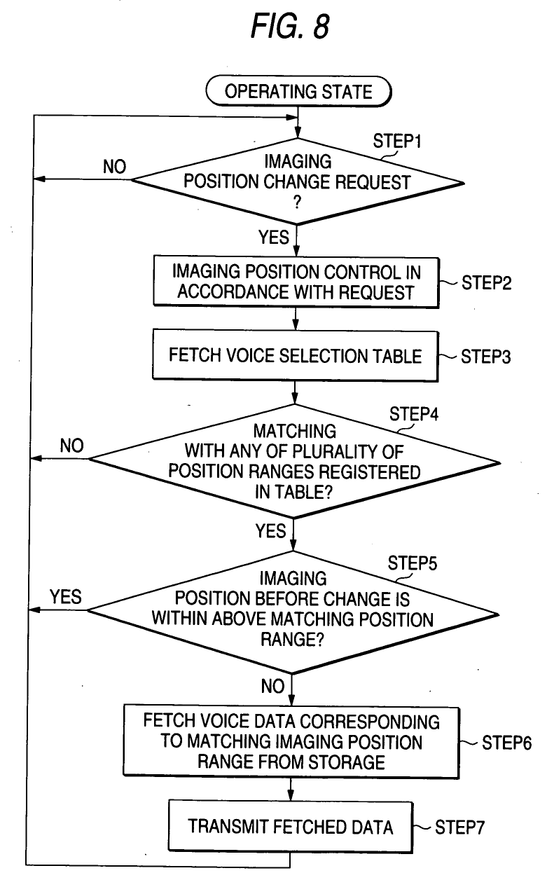

In the sequences sq5 and sq6 described above, the processing of reading data by the image server will be detailed. FIG. 8 is a flowchart of voice data read processing according to Embodiment 1 of the invention. As shown in FIG. 8, it is checked whether a camera imaging position change request has been transmitted (step 1) and in case the request has not been transmitted, the image server enters the wait state. In case the request has been transmitted, imaging position control is made in accordance with the imaging position range specified by the camera imaging position change request (step 2). The voice selection table 9d is fetched (step 3). It is checked whether the imaging position of the camera imaging position change request matches the range of the plurality of imaging positions registered to the voice selection table 9d (step 4). In case matching is determined, it is determined whether the imaging position before change is within the imaging position range which matched in step 4 (step 5). In case the imaging position is not within the imaging position range in step 4 and the imaging position is matched in step 5, execution returns to step 1. In step 5, in case the imaging position before the camera imaging position change request does not match the imaging position range which matched in step 4, voice data corresponding to the imaging position range which matched in step 5 is fetched from the voice data storage 9c (step 6). Next, the fetched voice data is transmitted to the terminal 2 (step 7).

In this way, according to the image server and the image server system of Embodiment 1, the user can comfortably operate the camera via a network and acquire information associated with the imaging position of the camera.

As in Embodiment 2 mentioned later, matching between the rate of overlapping with a imaging position range may be employed instead of a imaging position to determine matching with the range of a plurality of imaging positions.

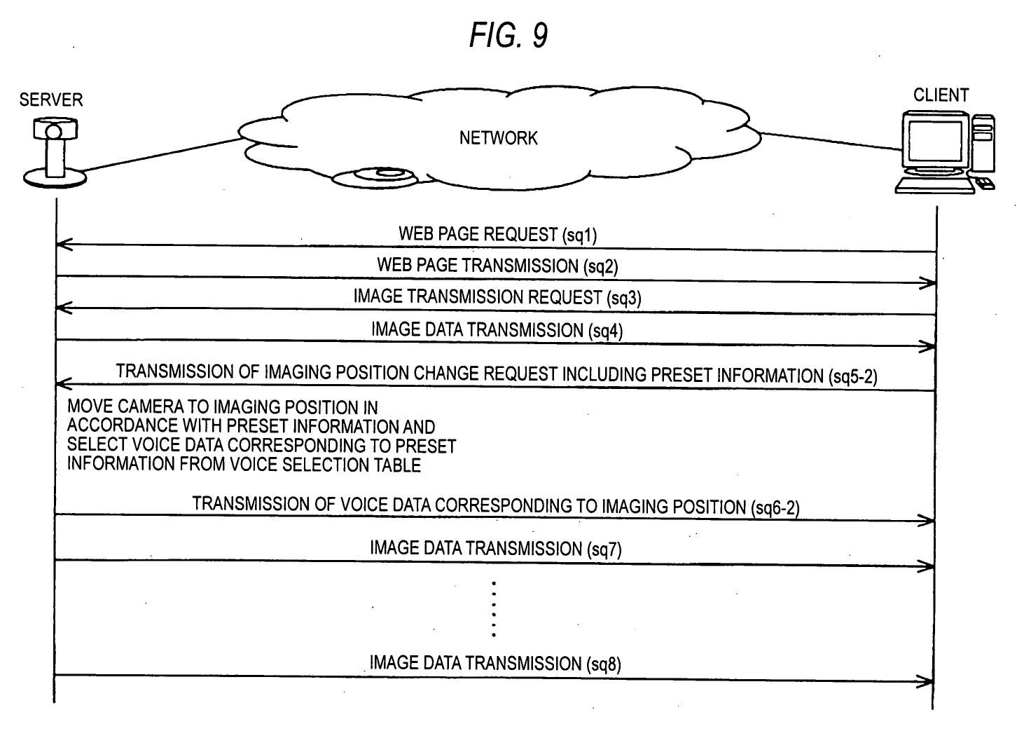

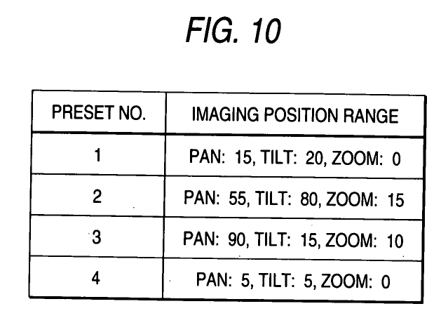

While the client transmits a camera imaging position change request in the above example, another approach is possible where a plurality of preset buttons, for example preset buttons 1 through 4 are provided on the control screen of the terminal and the image server, in response to the operation of the button, previously moves the camera to the imaging position corresponding to the preset button, references the voice selection table in FIG. 6B, and transmits the time the preset button information was received and the voice data corresponding to the preset button information (preset buttons NO. 1 through NO. 4) to the terminal. FIG. 9 is a sequence chart of acquisition of the image and voice information in the image server system according to Embodiment 1 of the invention. FIG. 10 explains the preset table of the image server according to Embodiment 1 of the invention. The corresponding server operation is described below using the sequence chart of FIG. 9. In FIG. 9, sequences sq1, sq4, sq7 and sq8 are similar to those in FIG. 7 so that the corresponding description is omitted. Only the sequence sq5-2 and sq6-2 will be described. In sq5-2, the user at the client browses the still images transmitted. In case the user wishes to browse images imaged in the imaging direction corresponding to a predetermined preset position, presses any of the preset buttons 1 through 4. This transmits a imaging position change request including the received preset number. Receiving the preset number, the image server 1 references the preset table in FIG. 10, fetches the imaging position corresponding to the received preset number, and operates the drive section 12 so as to position the camera in the imaging position fetched. The image server 1 reads the voice data corresponding to the preset number from the voice selection table (see FIG. 6B) and transmits the voice data to the terminal 2 (sq6-2).

In this way, according to the image server and the image server system of Embodiment 1, the user can comfortably operate the camera via a network and acquire information associated with the preset information of the camera.

### Embodiment 2

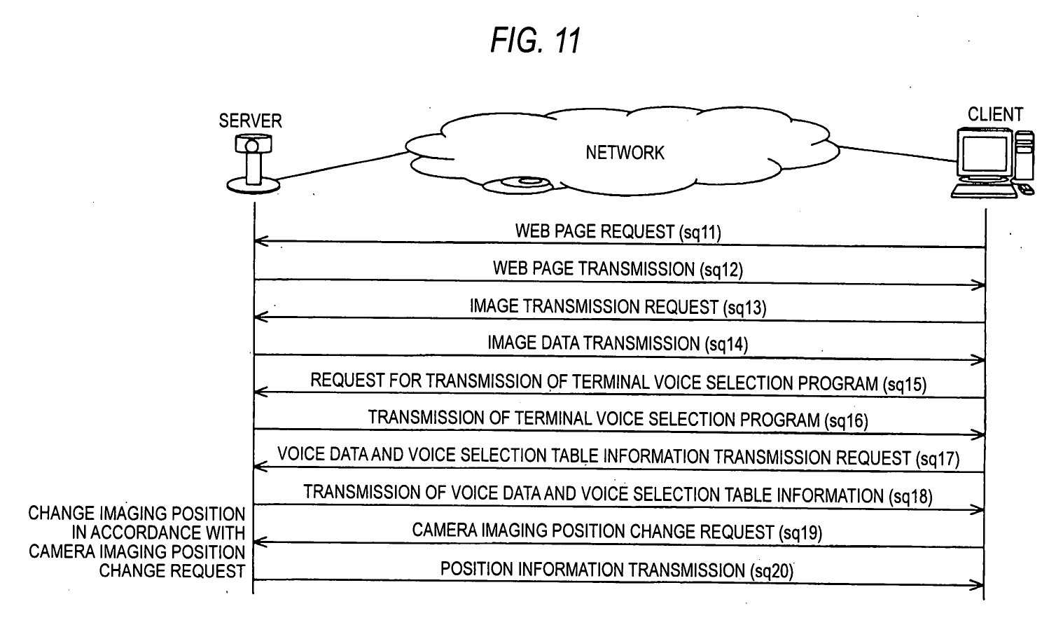

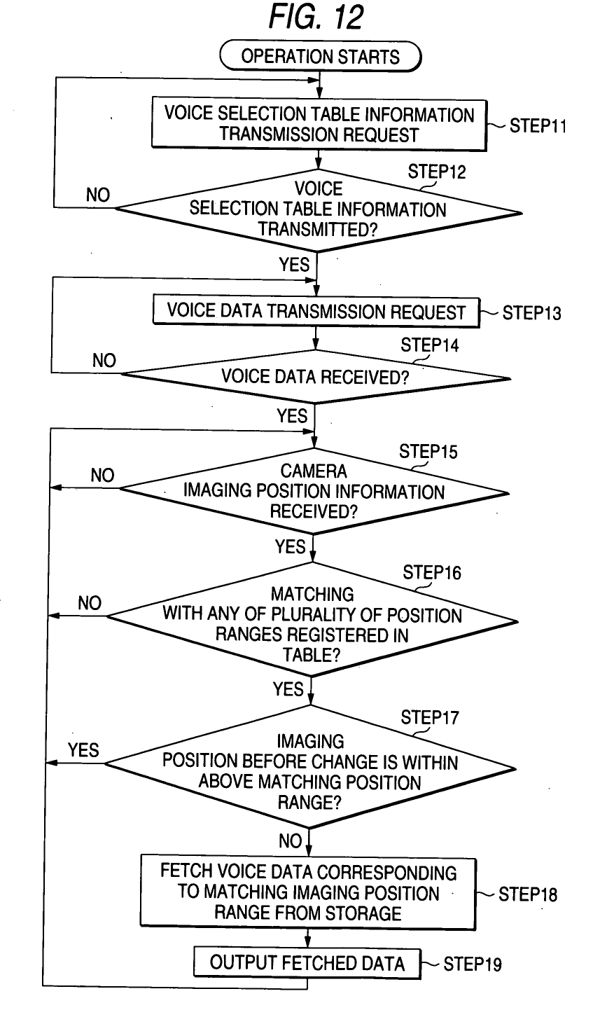

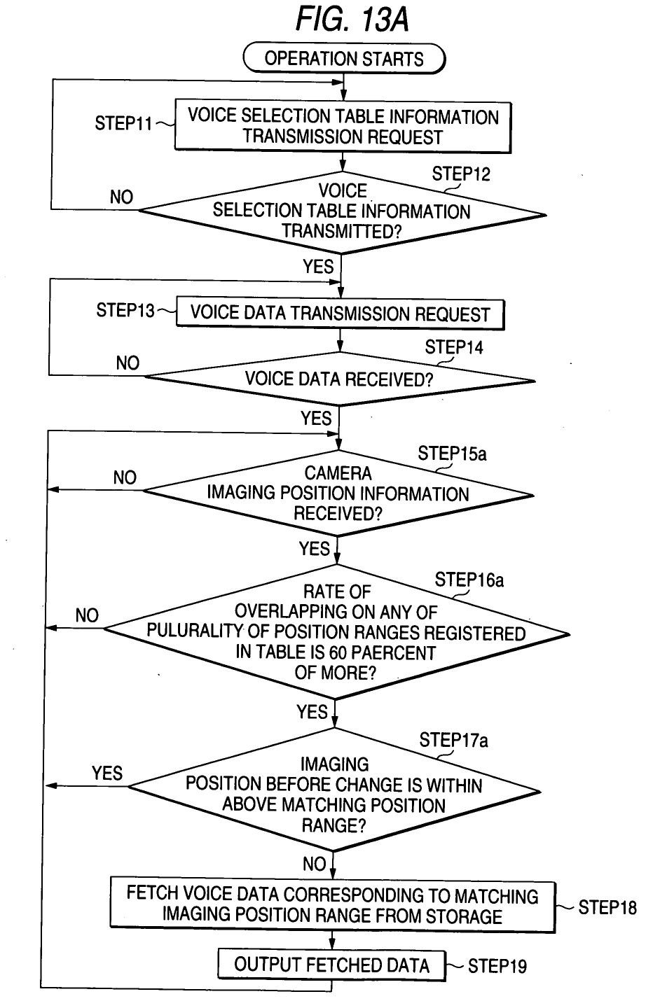

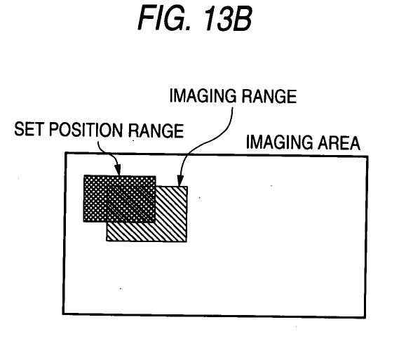

An image server 1 according to Embodiment 2 of the invention is described below referring to drawings. FIG. 11 is a sequence chart of acquisition of the image and voice information in the image server system according to Embodiment 1 of the invention. FIG. 12 is a flowchart of voice data read processing according to Embodiment 2 of the invention. FIG. 13A is a second flowchart of voice data read processing according to Embodiment 2 of the invention. FIG. 13B explains the matching determination of a set imaging position range. An image server system comprising an image server and a terminal according to Embodiment 2 is basically the same as the image server system comprising an image server and a terminal according to Embodiment 1 so that detailed description is omitted while FIGS. 1 through 6 are being referenced.

In FIG. 11, on the client terminal 2, a web page of the control screen is requested from the image server 1 by using the protocol http via a network (sq11). The image server 1 transmits an HTML-based web page carrying layout information for displaying the camera 7 to display an image (sq12). The web page describes an instruction to make a request for transmission of a terminal voice selection program via a JAVA ® applet and plug-in software.

On the terminal 2 which received the web page, the browser means displays the web page on the display and makes an image transmission request to the image server 1 by using icons (sq13). The image server 1 reads still images encoded in the motion JPEG format and transmits the image data in predetermined intervals (sq4).

The terminal 2 requests transmission of a terminal voice selection program for acquisition and regeneration of voice data (sq15). In response, the image server 1 reads the terminal voice selection program from a terminal voice selection program storage 9f and transmits the programs to the terminal 2 (sq16) The terminal 2 incorporates the terminal voice selection program into browser means 20 to extend the browser feature. The extended browser means 20 makes a voice data and voice selection table information transmission request (sq17) and the image server 1 transmits voice data and voice selection table information (sq18).

Now the voice data and voice selection table as well as a terminal voice selection program to select the image server 1 are downloaded to the storage 21. It is thus possible to use a voice selection table to select and regenerate voice data in the terminal 2. The image server uses control buttons and icons on the control screen to make a camera imaging position change request (sq19). The image server 1 transmits received imaging position information (sq10). Receiving the information, the terminal voice selection program of the client fetches voice data from a storage 21 corresponding to the imaging position in accordance with the voice selection table information and outputs the voice from voice output means 25. The imaging position information from the image server 1 may be responded with a URL indicating the imaging position changed based on the camera imaging position change request (for example a CGI format of the URL37 in FIG. 4). Receiving a camera imaging position change request from the client, the image server 1 transmits imaging position information to the client.

In the sequences sq17 through sq20 described above, operation of the terminal voice selection program will be detailed. As shown in FIG. 12, the terminal makes a request for voice selection table information to the image server (step 11) and it is checked whether voice selection table information has been received (step 1) and in case the information has not been transmitted, the terminal enters the wait state. In case the information has been received, the terminal makes a voice data transmission request (step 13) and it is checked whether voice data has been received (step 14). The terminal waits until the data is received.

It is checked whether camera imaging position information has been transmitted (step 15) and the terminal waits until the information is received. When the information is received, it is checked whether the imaging position of the camera imaging position change request matches the range of the plurality of imaging positions registered to the voice selection table (step 16). In case matching is determined, it is determined whether the imaging position before change is within the imaging position range which matched in step 4 (step 17). In case the imaging position is not within the imaging position range in step 16 and the imaging position is matched in step 17, execution returns to step 15. In step 17, in case the imaging position before the camera imaging position change request does not match the imaging position range which matched in step 16, voice data corresponding to the imaging position range which matched in step 16 is fetched from the a storage 21 (step 18). Next, the fetched voice data is output as a sound signal from the voice output means 25 (step 19). Execution then returns to step 15.

In the sequences sq17 through sq20, matching determination of the imaging position range may be a separate process. As shown in FIGS. 13A and 13B, steps 11 through 14 are same as the process in FIG. 12. Instead of step 15 in the process of FIG. 12, it is checked whether the imaging position range information has been received (step 15a) and the terminal waits until it is received. The alternative method for matching determination assumes matching of a imaging position range when the rate of overlapping of the set position range in the voice selection table and the imaging position (=overlapping range/imaging position) is 60 percent or more, as shown in FIG. 13B.

When the camera imaging position information is received, it is checked whether the rate of the imaging position of the camera imaging position change request overlapping any of the ranges of a plurality of imaging positions is 60 percent or more (step 16a). In case the rate is 60 percent or more, whether the imaging position before change is within the set imaging position range of the overlapping imaging positions in step 16a is determined (step 17a). In case overlapping rate is less than 60 percent in step 16a and the set imaging position range of the overlapping imaging positions is exceeded in step 17a, execution returns to step 15. In case the imaging position before the camera imaging position change request is not within the set imaging position range of the imaging positions overlapping by 60 percent or more in step 16a, the voice data corresponding to the set imaging position range of the imaging positions overlapping by 60 percent or more in step 16a is fetched from the storage 21 (step 18). The voice data is then output as a sound signal from the voice output means 25 (step 19). Execution returns to step 15.

In this way, according to the image server and the image server system of Embodiment 1, the image server transmits a terminal voice selection program, voice data and voice selection table information for a JAVA ® applet and plug-in software to the terminal. This eliminates the need for processing voice on the image server. Once image data is downloaded to a client terminal, the user can conformably operate the camera via a network and voice data associated with the imaging position of the camera can be delivered as voice by way of the internal processing of the terminal.

While the terminal voice selection program requests voice data and a voice selection table in Embodiment 2, the user may describe on a web page a request for transmission of voice data and the voice selection table.

In step 15 in FIG. 12, instead of the imaging position information, preset information may be used. Processing of steps 16 and 17 may be omitted and voice data corresponding to the matching preset information may be used instead of voice data corresponding to the matching imaging position range in step 18. This allows operation triggered when the preset button is pressed on the terminal.

### Embodiment 3

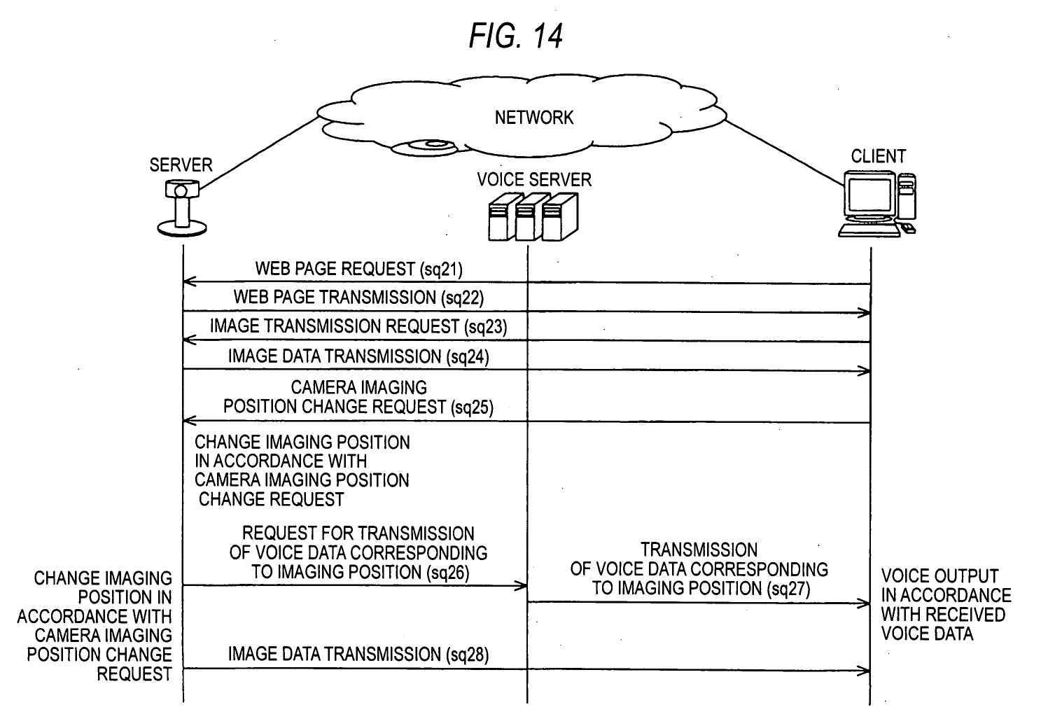

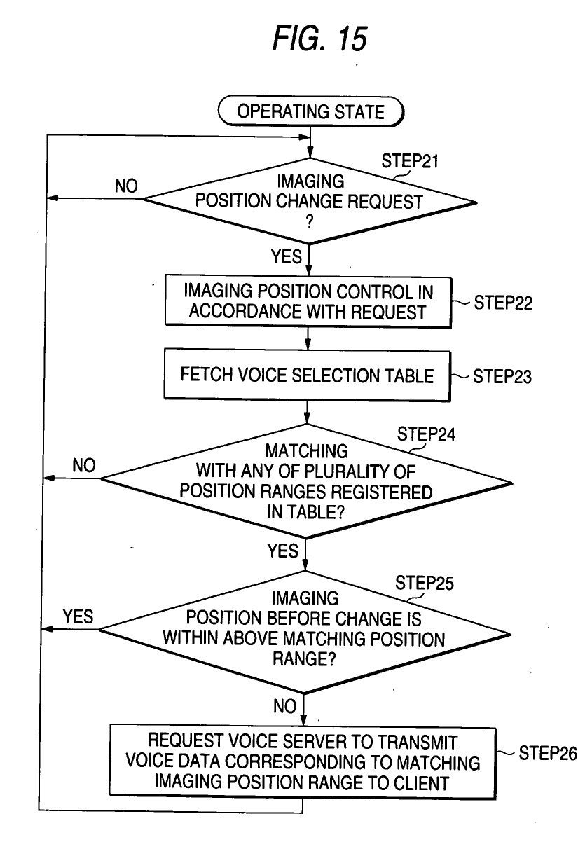

An image server system according to Embodiment 2 of the invention is described below referring to drawings. FIG. 14 is a sequence chart of acquisition of an image and voice information in an image server system according to Embodiment 3 of the invention. FIG. 15 is a flowchart of voice data read processing according to Embodiment 3 of the invention. An image server system comprising an image server and a terminal according to Embodiment 3 is basically the same as the image server system comprising an image server and a terminal according to Embodiment 1 so that detailed description is omitted while FIGS. 1 through 6 are being referenced.

In the image server system according to Embodiment 3, the voice server 6 shown in FIG. 1 transmits voice data to the terminal 2 in response to a request received from the image server 1.

In FIG. 14, on the client terminal 2, a web page of the control screen is requested from the image server 1 by using the protocol http via a network (sq21). The image server 1 transmits an HTML-based web page carrying layout information for displaying the operation buttons of the camera 7 and images (sq22).

On the terminal 2 which received the web page, the browser means displays the web page on the display and makes an image transmission request to the image server 1 by using icons (sq23) The image server 1 reads still images encoded in the motion JPEG format and transmits the image data in predetermined intervals (sq24).

The user at the client browses the still images transmitted. In case the user wishes to browse images imaged in another imaging direction, the client transmits a camera imaging position change request (sq25). The image server 1 operates the drive section 12 to change the camera imaging position and transmits a voice data transmission request to the voice server 6 in order to request voice data corresponding to the imaging position (sq6). The voice server 6, receiving the voice data, reads the voice data corresponding to the imaging position and transmits the voice data to the terminal 2 (sq27). Further, the voice server 6 transmits image data of successive still images encoded in the motion JPEG format imaged in a separate direction (sq28) In case the mode of image transmission in sq24 sis a mode where successive images are transmitted in predetermined time intervals, a single still image is preferably transmitted in sq24. In sq26, instead of transmitting predetermined voice data from the terminal 2 to the voice server 6, imaging position information may be temporarily received by the terminal 2 and the terminal 2 may make a request for voice data to the voice server 6 based on the imaging position information.

In the sequences sq25 and sq26 described above, the processing of reading voice data by the image server will be detailed. FIG. 15 is a flowchart of voice data read processing according to Embodiment 3 of the invention. As shown in FIG. 15, it is checked whether a camera imaging position change request has been transmitted (step 21) and in case the request has not been transmitted, the image server enters the wait state. In case the request has been transmitted, imaging position control is made in accordance with the imaging position range specified by the camera imaging position change request (step 22). The voice selection table is fetched (step 23). It is checked whether the imaging position of the camera imaging position change request matches the range of the plurality of imaging positions registered to the voice selection table (step 24). In case matching is determined, it is determined whether the imaging position before change is within the imaging position range which matched in step 24 (step 25). In case the imaging position is not within the imaging position range in step 24 and the imaging position is matched in step 25, execution returns to step 21. In step 25, in case the imaging position before the camera imaging position change request does not match the imaging position range which matched in step 24, a request is made from the voice server 6 to the terminal 2 to transmit voice data corresponding to the imaging position range which matched in step 25 (step 26). The voice server 6 transmits the voice data to the terminal 2. Execution then returns to step 21.

In this way, according to the image server and the image server system of Embodiment 3, a voice selection table shown in FIG. 5 can be stored in the voice server. This eliminates the need for processing voice on the image server. The user can conformably operate the camera via a network. Simply providing a voice server for voice processing readily acquires via voice the information associated with the imaging position. While the image server selects voice data in Embodiment 3, the voice server may include a voice selection table. In this case, the image server transmits imaging position information to the voice server, which selects and transmits voice data.

### Embodiment 4

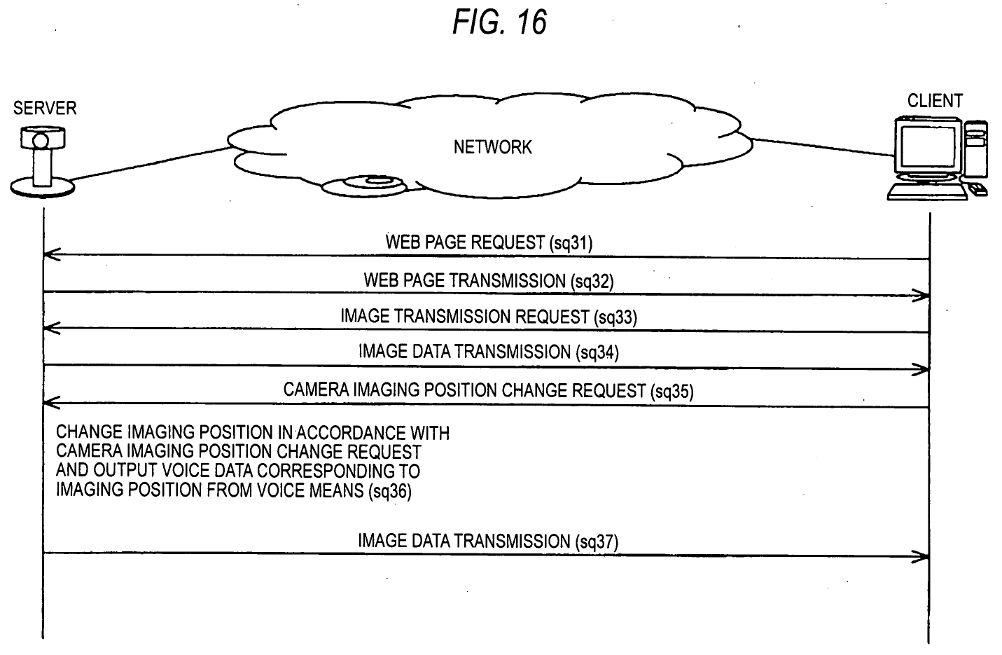

Next, an image server system capable of delivering voice from an image server according to Embodiment 4 is described below. FIG. 16 is a sequence chart of acquisition of an image in an image server system and voice regeneration from the image server. An image server system comprising an image server and a terminal according to Embodiment 4 is basically the same as the image server system comprising an image server and a terminal according to Embodiment 1 so that detailed description is omitted while FIGS. 1 through 6 are being referenced.

As shown in FIG. 16, on the client terminal 2, a web page of the control screen is requested from the image server 1 by using the protocol http via a network (sq31). The image server 1 transmits an HTML-based web page carrying layout information for displaying the operation buttons of the camera 7 to display images (sq32). The terminal 2 receives the web page and the browser means displays the web page on the display. The user makes an image transmission request to the image server 1 by using the control buttons and icons on the control screen (sq33). The image server 1 reads successive still images encoded in the motion JPEG format and transmits the image data (sq34).

The user at the client browses the still images transmitted. In case the user wishes to browse images imaged in another imaging position, the client transmits a camera imaging position change request (sq35). The image server 1 operates the drive section 12 to change the camera imaging position, reads the voice data to be delivered by the image server, the voice data corresponding to the imaging position, and regenerates the voice data from the voice output means 15 of the image server 1 (sq36). Further, the image server 1 transmits the image data of successive still images imaged in another orientation and encoded in the motion JPEG format (sq37). The image server 1 transmits successive still pictures by repeating sq35 trough sq37 (sq38).

In this way, according to the image server and the image server system of Embodiment 4, voice data delivered from the image server may be stored in the image server and a voice guidance may be given from the loudspeaker of the image server when the image is requested. This allows the user to operate the camera comfortably via a network as well as upgrades the voice service on the image server.

As mentioned hereinabove, an image server according to the invention provides a voice associated with the camera orientation and position. This facilitates camera operation and increases the information volume to be transmitted. The image server transmits image information as well as surrounding voice collected to the client terminal. This increases the monitor information by way of the image server, which makes the invention more useful in an application such as a monitor camera. Moreover, by delivering a voice message associated with the imaging direction of the camera from the loudspeaker of the image server, it is possible to deliver voice information toward the camera imaging direction, thereby allowing bidirectional communications.

While description has been made for each of Embodiments 1 through 4, a combination of these embodiments may be also used.

What is claimed is:

1. An image server connected to a network which controls a camera within each imaging position range based on a request from a client terminal via the network, comprising:
a storage, which stores voice data to be regenerated on the client terminal;
a table, which associates the voice data with imaging position data of the camera; and
a controller, which, in case the imaging position of the camera corresponds to the imaging position data in the table, selects the voice data associated with the imaging position data and controls a network server section to transmit the voice data to the client terminal.

2. The image server according to claim 1,
wherein the table stores the imaging position data indicating the imaging position range, imaging time information and voice data while associating their storage locations with one another.

3. The image server according to claim 1 or 2, wherein
the storage stores a display selection table, which selects display information associated with the imaging position data of the camera.

4. The image server according to claim 3, wherein
an active area for transmitting control data is provided in the display information.

5. The image server according to claim 3, wherein
a telop display area for displaying telop-type indication information is provided in the display information.

6. The image server according to any of claims 1 through 5, wherein
correspondence of the imaging position of the camera to the imaging position data in the table is determined by whether the imaging position of the camera is included in the imaging position range of the table.

7. The image server according to any of claims 1 through 5, wherein
correspondence of the imaging position of the camera to the imaging position data in the table is determined by the rate of overlapping of the imaging range on the imaging position range of the table.

8. The image server according to any of claims 1 through 7, wherein the network server section transmits data of an image imaged with the camera to said client terminal.

9. The image server according to any of claims 1 through 8, further comprising;
voice output means, which outputs voice, wherein selected voice data is outputted from the voice output means.

10. An image server connected to a network which controls a camera within each imaging position range based on a request from a client terminal via the network, comprising:
a storage, which stores voice data to be regenerated on the client terminal and a table, which associates the voice data with preset information,
wherein, in receiving a imaging position change request including the preset information from the client terminal, a controller selects voice data associated with the preset information, and
a network server section transmits the voice data to the client terminal.

11. The image server according to claim 10, wherein
the table stores the preset information, imaging time information and the voice data while associating their storage locations with one another.

12. The image server according to claim 11 or 12, wherein a display selection table, which selects display information associated with the preset information is stored in the storage.

13. The image server according to claim 12, wherein an active area for transmitting control data is provided in the display information.

14. The image server according to claim 12, wherein
a telop display area for displaying telop-type indication information is provided in the display information.

15. The image server according to any one of claims 10 through 14, wherein the network server section transmits image data to the client terminal.

16. The image server according to any of claims 10 through 15, wherein
the image server comprises voice output means for outputting voice, the image server outputting selected voice data from the voice output means.

17. An image server connected to a network which controls a camera within each imaging position range based on a request from a client terminal via the network, comprising:
a storage, which stores voice data to be regenerated on a client terminal and a table which associates the voice data with preset information and
voice output means, which outputs voice, wherein in case the imaging position of the camera corresponds to the imaging position data in the table, a controller selects voice data associated with the imaging position data and outputs the selected voice data from the voice output means.

18. An image server connected to a network which controls a camera within each imaging position range based on a request from a client terminal via the network, comprising:
a storage, which stores a table which associates voice data to be regenerated on a client terminal with imaging position data of the camera,
wherein in case the imaging position of the camera corresponds to the imaging position data in the table, a network server section makes a request to a voice server connected to a network which stores voice data to transmit the voice data.

19. An image server system comprising an image server connected to a network which drives a camera to transmit an image and a client terminal which controls the camera via the network,
wherein the image server comprises;
a storage, which stores voice data to be regenerated on a client terminal and a table which associates the voice data with imaging position data of said camera,
wherein in case the imaging position of the camera corresponds to the imaging position data in said table, the image server selects voice data associated with the imaging position data and transmits the voice data to the client terminal.

20. An image server system comprising an image server connected to a network which drives a camera to transmit an image within each imaging position range and a client terminal which controls the camera via the network, wherein
the image server comprises a storage for storing voice data to be regenerated on a client terminal, a table which associates the voice data with imaging position data of the camera, and a program which causes a computer to act as means for selecting the voice data, wherein
when a request for an image is made by the client terminal, the image server transmits the program, the voice data and the table to the client terminal as well as transmits a imaged image and imaging position information, and wherein
receiving the image, the client terminal selects the voice program by way of the program to regenerate voice.

21. An image server system comprising an image server connected to a network which drives a camera to transmit an image within each imaging position range and a client terminal which controls the camera via the network, comprising;
a voice server, which stores voice data to be regenerated on the client terminal and is connected to the network,
wherein when a request for an image is made by the client terminal, in case the imaging position of the camera corresponds to the imaging position data in the table, a controller of the image server selects voice data associated with the imaging position data and
the image server makes a request for transmission of the voice data to the client terminal.

22. An image server system comprising an image server connected to a network which drives a camera to transmit an image within each imaging position range and a client terminal which controls the camera via the network, wherein
the voice server comprises a storage, which stores voice data to be regenerated on voice output means and a table which associates the voice data with the client terminal and wherein
On a request by the client terminal, the image server regenerates the voice data.

23. A program which causes a computer as voice data selection means for fetching voice data from a storage based on the camera imaging position transmitted from an image server and output means for outputting the fetched voice data onto voice output means.

24. A computer-readable recording medium on which is recorded a program which causes a computer as voice data selection means for fetching voice data from a storage based on the camera imaging position transmitted from an image server and output means for outputting the fetched voice data onto voice output means.

25. The image server according to any one of claims 1, 17, 18, 19, 20, 21, wherein the imaging position data includes a panning data, a tilting data, and a zooming data of the camera.
